(19) United States
(12) Patent Application Publication
(10) Pub. No.: US 2016/0272217 A1
(43) Pub. Date: Sep. 22, 2016

(54) TWO-STEP SLEEPY DRIVING PREVENTION APPARATUS THROUGH RECOGNIZING OPERATION, FRONT FACE, EYE, AND MOUTH SHAPE

(71) Applicant: Jae-Chul KIM, Gangnam-gu Seoul (KR)

(72) Inventors: Jae-Chul KIM, Seoul (KR); Jae-Kwan KO, Namyangju (KR); Su-Jin PARK, Seoul (KR); Woo-Chang KIM, Seoul (KR); Chang-Hui LEE, Seongnam (KR)

(21) Appl. No.: 15/032,695

(22) PCT Filed: Oct. 27, 2014
(86) PCT No.: PCT/KR2014/010118

§ 371 Date: Apr. 28, 2016

(30) Foreign Application Priority Data
Oct. 29, 2013 (KR) 10-2013-0129628

(51) Int. Cl. B60W 40/09; B60Q 9/00; G06K 9/00; G01S 19/13

(52) U.S. Cl. CPC B60W 40/09; G01S 19/13; B60Q 9/00; G06K 9/00845; G06K 9/00281; G06K 9/00275; G06K 9/0061; G06K 9/00255; G06K 9/00248; B60W 2040/0827

(57) ABSTRACT

Disclosed therein is a two-step drowsy driving prevention apparatus through motion, face, eye, and mouth recognition. A driving judging unit which includes a GPS device to detect a driving state of a vehicle and a drowsiness judging unit which receives image and three-dimensional depth information from a photographing unit including an infrared depth sensor and an infrared camera mounted at positions to observe a driver's face judge a cycle of a yawn, a speed and a cycle of nodding the head and a speed and a cycle of a blink of the eye as a first step judgment. When it is judged that there is a drowsiness prelude action, the apparatus outputs a “preliminary warning”. After that, a warning unit outputs a “main warning” when there is a drowsiness execution action by inspecting a closed state of the eye, a forward looking state of the eye and an angle of the head as a second step judgment so as to accurately judge only a drowsy driving action except the closed state of the eye and the case that the driver does not look at the front or bends the head other than drowsiness through the two-step stepwise judging method based on various judgment criteria, such as the driver's motion, face, pupil and a mouth shape, thereby preventing traffic accidents, human casualties and economic loss due to drowsy driving.

### TECHNICAL FIELD

The present invention relates to a two-step drowsy driving prevention apparatus through motion, face, eye and mouth recognition, and to a drowsy driving prevention apparatus using a stepwise method of two steps, which starts to detect a driver's drowsiness state only when a vehicle is driving forward after judging a forward driving state of the vehicle using a GPS device, recognizes the driver's motion, face, eyes and shape of yawning mouth using an infrared depth sensor and an infrared camera in order to more accurately judge whether or not the driver is driving the vehicle while drowsiness, passes through a first step of judging a prelude stage to drowsiness in order to accurately detect the drowsy driving excepting cases where the driver closes the eyes due to the reason other than drowsy driving or where the driver turns his or her gaze upon something else and a second step of judging whether or not the driver is drowsing, and finally determines the drowsy driving only when satisfying at least one of the conditions of the first step and then satisfying at least one of the conditions of the second step.

### BACKGROUND ART

As related arts of drowsy driving prevention apparatuses, there are Korean Patent No. 10-1139963 entitled “Method and apparatus for preventing drowsy driving using detection of a driver's pupils”, which judges a drowsy driving based on only a pupil region, especially, the size and the degree of circularity of the pupils and outputs a warning signal, Korean Patent No. 10-0778059 entitled “Drowsy driving prevention apparatus using facial recognition technology and drowsy driving prevention system using same”, which compares and analyzes a vector template of a driver's face generated by a facial image reading unit and a stored vector template of the driver's face, and Korean Patent Laid-open No. 10-2012-0086572 entitled “Drowsy driving prevention method of vehicle driving guide apparatus”, which suspects whether a driver is driving while drowsiness when a driving speed of the vehicle greatly deviates from the average speed and makes a phone call to the driver in order to prevent driving while drowsiness.

However, such related arts have several disadvantages in that the apparatus judges that the driver is driving drowsily even when the driver closes the eyes or gazes at some place in the vehicle which stops so as to cause inconvenience the driver because the apparatus operates even when the vehicle stops, and in that the apparatus wrongly judges that the driver is driving drowsily for the reason that the driver is looking at a different location for the reason that the driver is looking at a different location even when the driver is looking back or looking in the rearview mirror while the vehicle is moving backwards.

Also, a method of comparatively analyzing a driver's vector template generated from a facial image decoding unit and a driver's vector template stored beforehand is difficult to discriminate whether the generated vector template is caused by drowsy driving or is caused by different reasons because judging the drowsy driving whenever the generated vector template is different from the driver's vector template stored beforehand, and may produce inaccurate results when hastily concluding the drowsy driving for the simple reason that the generated vector template is different from the stored vector template.

Moreover, the related arts judge the drowsy driving by judging only the driver's pupils or only by an open/close state of the pupils so that it is completely impossible to judge drowsy driving in situations of being unable to recognize the driver's eyes due to obstacles, such as sunglasses or eyeglasses, etc., and also judge all situations when the driver gazes at different locations or closes the eyes or the driver's pupils are closed for different reasons other than the drowsy driving. Thus, the related arts are very low in accuracy.

Furthermore, the drowsy driving prevention method which judges drowsy driving when the speed of the vehicle is above the average speed according to the related art has a critical disadvantage in that it is impossible to judge whether the driver is drowsy or the method is low in accuracy when a driving speed greatly deviates from the average speed due to reasons other than drowsy driving or when it is impossible to recognize movement or speed of the vehicle due to a surrounding environment acting as an obstacle.

### DISCLOSURE

### Technical Problem

Accordingly, the present invention has been made in an effort to solve the above-mentioned problems occurring in the prior arts, and it is an object of the present invention to provide a drowsy driving prevention apparatus using a stepwise method of two steps, which starts to detect a driver's drowsiness state only when a vehicle is driving forward after judging a forward driving state of the vehicle using a GPS device, recognizes the driver's motion, face, eyes and shape of yawning mouth using an infrared depth sensor and an infrared camera in order to more accurately judge whether or not the driver is driving the vehicle while drowsiness, passes through a first step of judging a prelude stage to drowsiness in order to accurately detect the drowsy driving excepting cases where the driver closes the eyes due to the reason other than drowsy driving or where the driver turns his or her gaze upon something else and a second step of judging whether or not the driver is drowsing, and finally determines the drowsy driving only when satisfying at least one of the conditions of the first step and then satisfying at least one of the conditions of the second step.

### Technical Solution

To solve the problems described above, the present invention provides a two-step drowsy driving prevention apparatus through motion, face, pupil and mouth recognition, including: a driving judging unit to judge a forward driving state of a vehicle; a photographing unit to photograph a driver's condition; a drowsiness judging unit to judge whether or not the driver is driving while drowsiness; a warning unit to generate a warning sound; and a controller to control the driving judging unit, the photographing unit, the drowsiness judging unit and the warning unit, wherein the driving judging unit comprises: a first-step judging process to judge a drowsiness prelude action through recognition of the driver's motion, face, pupil and mouth shape only when the vehicle is moving forward by receiving coordinate information of the current location of the vehicle from a GPS terminal and comparing the coordinate information with coordinate information of location for several seconds before the current location in order to judge whether the vehicle is driving forward, is driving backward or is stopped; and a second step judging process to judge a drowsiness execution action, so that the drowsy driving prevention apparatus finally determines that the driver is in drowsy driving and generates a warning sound only when it is judged that there is a drowsiness execution action in the second step determination process after it is determined that there is the drowsiness prelude action of the first step.

Preferably, the drowsiness judging unit to judge the driver's drowsiness state is mounted to judge the drowsy driving state by receiving the image information from the infrared camera and the three-dimensional depth information from the infrared depth sensor only when the driving judging unit judges a forward driving state, and first recognizes whether or not the driver carries out any prelude action of drowsiness through the first-step judging process and judges whether or not the driver carries out drowsiness execution action through the second-step judging process, and then, finally determines drowsy driving only when going through the second step after passing the first step.

Preferably, the first step to judge the prelude action of the drowsiness judges the prelude action of the drowsiness by calculating a cycle of driver's yawn or calculating a speed and a cycle of nodding the head after first detecting the driver's face outline from image and sensor information transmitted from the photographing unit and detecting locations of the mouth, the head, the nose and the neck, or by calculating a speed and a cycle of blinking eyes after first detecting locations of the eyes and recognizing the outlines of the pupils and the whites and the irises of the pupils.

Preferably, the second step to judge the execution action state of the drowsiness judges that there is an execution action of the drowsiness when the driver who satisfies one of the criteria of the drowsiness prelude action of the first step closes the eyes for more than a predetermined period of time when the driver does not look at the front for more than a predetermined period of time or when the driver bends his or her head at the predetermined angle for more than a predetermined period of time.

### Advantageous Effects

The drowsy driving prevention apparatus according to present invention finally determines whether or not the driver is driving while drowsiness and generates a warning sound through judgment of vehicle traveling using the GPS terminal and through the two-step judgment of drowsy driving the infrared camera and the infrared depth sensor so as to obtain the following effects.

First, the drowsy driving prevention apparatus judges whether or not the driver is driving while drowsiness only when the vehicle is driving forward by applying variations in coordinate values of the GPS terminal so as to accurately judge the drowsy driving.

Second, the drowsy driving prevention apparatus more accurately judges whether or not the driver is driving while drowsiness by judging drowsy driving not only based on recognition of the pupils and the open/close state of the pupils but also a cycle of yawning, a speed and a cycle of blinking, an angle of the head and a speed and a cycle of a nod so as to effectively improve a low recognition rate of conventional systems.

Third, the drowsy driving prevention apparatus eliminates errors and inconveniences of making a warning signal in unnecessary situations other than the drowsy driving through the two-step stepwise drowsy driving judgment method of finally determining the drowsy driving only when proceeding to the second step of the drowsiness execution step.

Forth, the drowsy driving prevention apparatus detects the drowsy driving even at night using the infrared camera and the infrared depth camera, generates only a preliminary warning sound when judging a prelude action of the drowsy driving using the warning sound indicator, and then, generates a main warning sound when finally determining an execution action of the drowsy driving in order to protect the driver's life by shaking off the driver's drowsiness and preventing drowsy driving.

### DESCRIPTION OF DRAWINGS

FIG. 1 is a block diagram of a drowsy driving prevention apparatus according to an embodiment of the present invention.

FIG. 2 is a flow chart for judging a forward driving state by a driving judging unit according to the embodiment of the present invention.

FIG. 3 is a flow chart for judging a drowsiness prelude action of a first step by a drowsiness judging unit according to the embodiment of the present invention.

FIG. 4 is a flow chart for judging a drowsiness execution action of a second step by the drowsiness judging unit according to the embodiment of the present invention.

FIG. 5 is a flow chart for judging the drowsiness prelude action based on a cycle of yawning according to the embodiment of the present invention.

FIG. 6 is a flow chart for judging the drowsiness prelude action based on a speed and a cycle of nodding the head according to the embodiment of the present invention.

FIG. 7 is a flow chart for judging the drowsiness prelude action based on a speed and a cycle of blinking of the eyes according to the embodiment of the present invention.

FIG. 8 is a flow chart for judging the drowsiness execution action based on a duration time of a closed state of the driver's pupils according to the embodiment of the present invention.

FIG. 9 is a flow chart for judging the drowsiness execution action based on a duration time that the driver's eyes fall on the front according to the embodiment of the present invention.

FIG. 10 is a flow chart for judging the drowsiness execution action based on a duration time that the driver bends his or her head according to the embodiment of the present invention.

FIG. 11 is an integrated block diagram of a drowsiness judging process by the drowsiness judging unit through a photographing unit, namely, an infrared camera and an infrared depth sensor, according to the embodiment of the present invention.

### BEST MODE

The present invention is described in detail in reference to the accompanying figures.

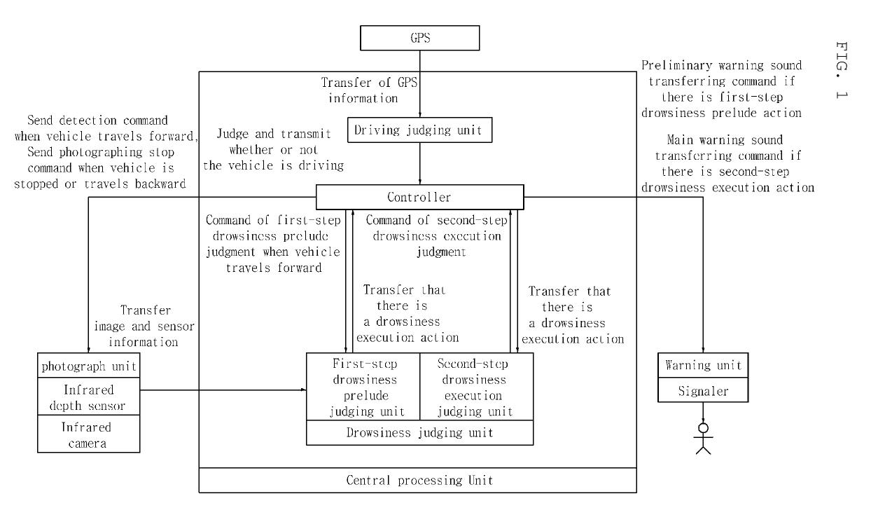

As shown in FIG. 1, a two-step drowsy driving prevention apparatus through recognition of a driver's motion, face, eyes and shape of the mouth goes through a first-step judging process of judging whether or not there is a prelude action of drowsiness through recognition of a driver's motion, face, eyes and shape of the mouth in a vehicle which is driving forward and a second-step judging process of judging whether or not there is a drowsiness execution action. The two-step drowsy driving prevention apparatus finally determines the driver's drowsy driving only when it is judged that there is a drowsiness execution action in the second-step judging process after judging the drowsiness prelude action in the first-step judging process, and then, generates a warning sound.

In more detail, as shown in FIG. 1, the two-step drowsy driving prevention apparatus according to the present invention includes a driving judging unit to judge a forward driving state of the vehicle; a photographing unit to photograph the driver's condition; a drowsiness judging unit to judge whether or not the driver is driving while drowsiness; a warning unit to generate a warning sound; and a controller to control the driving judging unit, the photographing unit, the drowsiness judging unit and the warning unit.

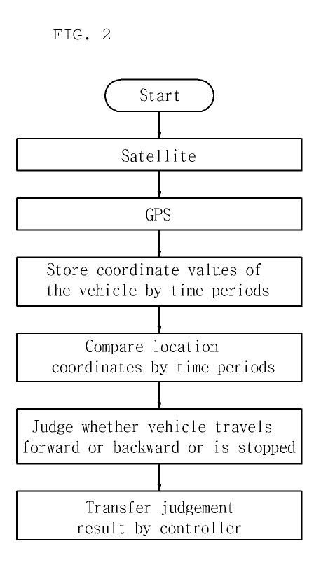

Here, the driving judging unit to judge the forward driving state of the vehicle receives coordinate information of a current location of the vehicle from a GPS terminal and compares the coordinate information with coordinate information of location for several seconds before the current location in order to judge whether the vehicle is driving forward, is driving backward or is stopped. FIG. 2 is a flow chart for judging a forward driving state by the driving judging unit. The driving judging unit receives location information, which is transmitted from a satellite for each time period, from a GPS terminal, stores coordinate values of the vehicle by time periods, and compares the coordinate values by time periods in order to judge whether the vehicle is driving forward, is driving backward or is stopped. If the vehicle is traveling in a normal situation, the vehicle does not continue the backward driving for a long time, for instance, at least 5 minutes. Even if the vehicle is traveling backwardly for such a long time, the driver might consciously look back or look at not the front but the rearview mirror for a long time in order to find obstacles which may exist at the back of the vehicle. Therefore, if these cases are judged as the drowsy driving, there is a high probability of making errors by mistaking the conscious turning of the head or the turning of the driver's eyes as a drowsy driving action. Moreover, because it is not necessary to judge the driver's drowsy driving while the driver is driving the vehicle backwardly since it really is a grim possibility that the driver carries out drowsy driving within a short moment while concentrating on backward driving, there is little need to judge whether or not the driver actually carries out drowsy driving while backward driving. So, in order to judge drowsy driving only when the vehicle is traveling forward, the drowsy driving prevention apparatus according to the present invention judges as stopping of the vehicle, for instance, if there is no change in former and latter coordinate values by time periods, judges as backward driving if the coordinate value suddenly (or the coordinate value temporarily does not vary) changes to the reverse direction from the former driving direction when comparing the former and the latter coordinate values with each other, and judges as forward driving if the coordinate values consistently vary in the same direction (or in a direction within an angel in which the vehicle can rotate but not in a reverse direction) for a predetermined period of time.

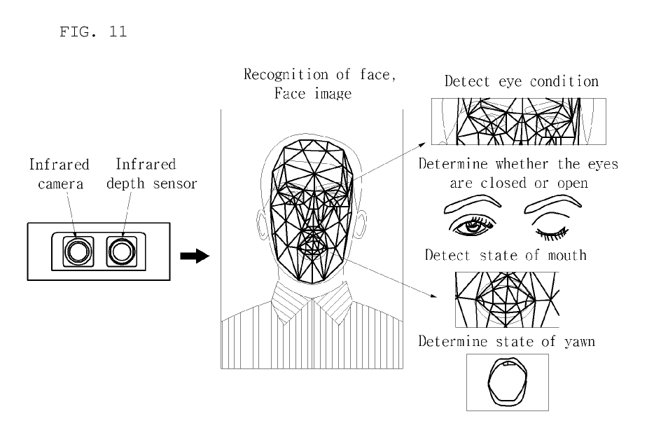

Additionally, the photographing unit to photograph the driver's condition, as illustrated in FIG. 11, includes an infrared camera to receive image information of the driver's facial state and an infrared depth sensor to receive three-dimensional depth information. The infrared camera receives the image information of the facial state and transmits the image information of the facial state to the drowsiness judging unit to recognize a face outline, an eye outline, the whites and irises of the eyes in a bright area as well as in a dark area. The infrared depth sensor receives the three-dimensional depth information and transmits the three-dimensional depth information to the drowsiness judging unit to accurately judge dispositions and movements of the upper body, the head, the face, eyes and the mouth in the bright area as well as in the dark area.

In addition, the drowsiness judging unit to judge the driver's drowsiness state, as illustrated in FIG. 1, includes a first-step drowsiness prelude judging unit and a second-step drowsiness execution judging unit. The drowsiness judging unit judges the drowsy driving state by receiving the image information from the infrared camera and the three-dimensional depth information from the infrared depth sensor only when the driving judging unit determines that the vehicle is in a forward driving state. In other words, the drowsiness judging unit first recognizes whether or not the driver carries out any prelude action of drowsiness through the first-step judging process and judges whether or not the driver carries out drowsiness execution action through the second-step judging process, and then, finally determines drowsy driving only when going through the second step after passing the first step.

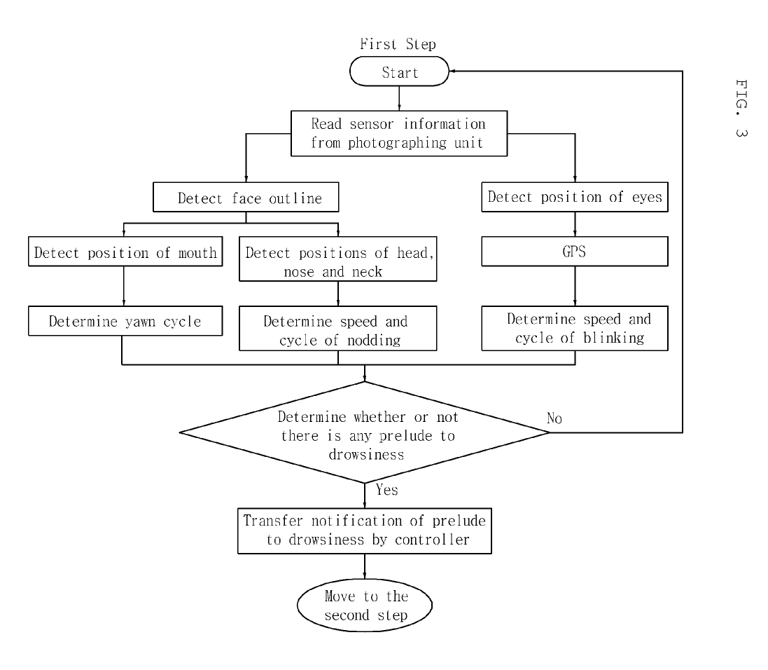

Here, the first step to judge the prelude action of the drowsiness, as illustrated in FIG. 3, judges the prelude action of the drowsiness by calculating a cycle of driver's yawning or calculating a speed and a cycle of nodding the head after first detecting the driver's face outline from image information transmitted from the photographing unit and three-dimensional depth information of the sensor and detecting locations of the mouth, the head, the nose and the neck, or by calculating a speed and a cycle of blinking eyes after first detecting locations of the eyes and recognizing the outlines of the pupils and the whites and the irises of the pupils.

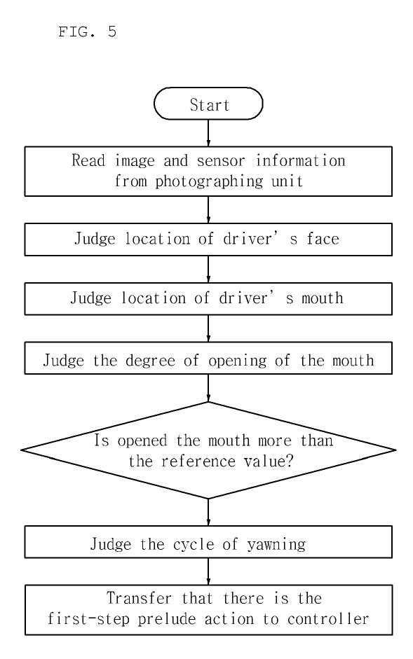

The cycle of yawning, which is one of the criteria to judge the prelude action of the drowsiness, as illustrated in FIG. 5, uses the image and the sensor information received from the photographing unit to identify the location of the driver's mouth, and then, it is judged that there is the prelude action of drowsiness when the number of yawning cycles exceeds the standard of the yawning cycles within a predetermined period of time after it is grasped that the shape of the mouth is formed to yawn. In more detail, the drowsiness judging unit judges the disposition of the mouth after recognizing the driver's face through the information received from the photographing unit. And then, the shape of the mouth is examined. For example, the apparatus determines one yawn when the mouth is opened at least 50% of a completely circular shape or when a state that the lower jaw is lower at least a predetermined degree than usual is sustained for at least a predetermined time, for example, 1 second, and judges the prelude step of the drowsy driving when the driver yawns at least a predetermined number of times, for example, two times, within a predetermined time, for example, 2 minutes.

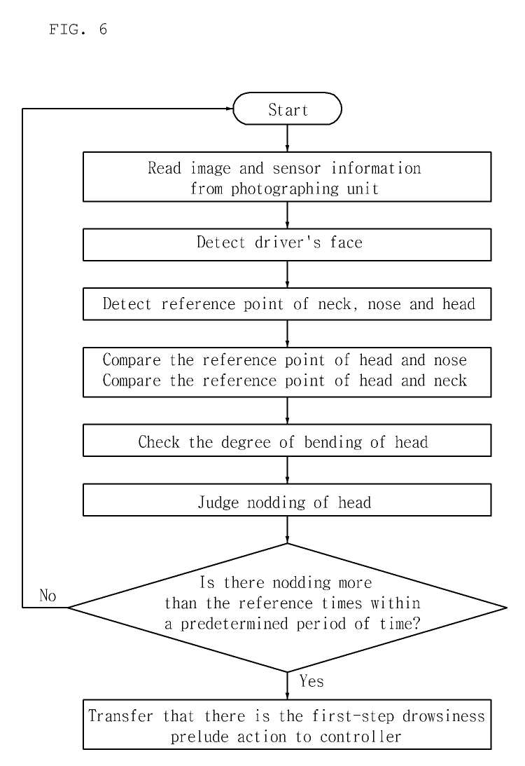

The speed and the cycle of nodding the head, which is one of the criteria of judging the prelude action of the drowsiness, as illustrated in FIG. 6, uses the image and the sensor information received from the photographing unit to regard as one nod when the driver's head bends more than a predetermined angle and returns to its initial state. The drowsy driving prevention apparatus calculates as a “nod as the prelude of drowsiness” only when one nod of the head spends more time than the standard time and judges that the prelude action of the drowsiness exists when the nod as the prelude of the drowsiness occurs more than a reference number of nods within a predetermined time. In more detail, the drowsiness judging unit takes each point of the head, the nose and the neck of the face of the driver through the information received from the photographing unit. And then, an angle is measured by using a connecting line of the head and the neck (straight line) and a connecting line of the head and the nose (straight line). For example, if the head is bent at least 30 degrees and then returns, this is counted as one nod and the time taken for the one nod is stored. When the one nod of the head requires at least a predetermined time, for instance, more than 3 seconds, the apparatus judges it as the prelude of the drowsiness and stores the time taken for the one nod. If the nod as the prelude of drowsiness occurs for at least a predetermined number of times (for example, at least two times) within a predetermined time (for example, within 3 minutes), the apparatus judges it as the prelude action of drowsiness.

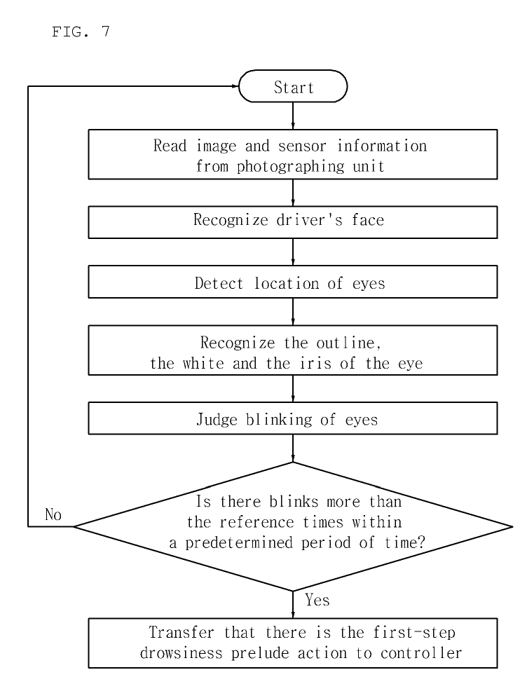

Moreover, the speed and the cycle of blinking eyes, which is one of the criteria of determining the prelude action of the drowsiness, as illustrated in FIG. 7, uses the image and the sensor information received from the photographing unit to regard that the driver's pupils are covered more than a predetermined portion and then uncovered as one blink. The drowsy driving prevention apparatus calculates as a “blink as the prelude of drowsiness” only when one blink of the eyes spends more time than the standard time and judges that the prelude action of the drowsiness exists when the blink as the prelude of the drowsiness occurs more than a reference number of blinks within a predetermined time. In more detail, the drowsiness judging unit recognizes the outline of the eye, the white and iris of the eye of the driver through the information received from the photographing unit, and regards as one blink, for example, when at least 50% of the pupil is covered and then at least 50% of the pupil returns to the open state of the eye, and then, stores the time taken for the one blink of the eye. When the time taken for the one blink of the eye takes at least a predetermined reference time, for example, at least one second, the drowsiness judging unit judges and calculates it as a blink as the prelude of the drowsiness, and then, judges that there is a prelude action of drowsiness when the blinks as the prelude of drowsiness occurs at least a predetermined number of times, for example, at least two times, within a predetermined time, for example, within 1 minute.

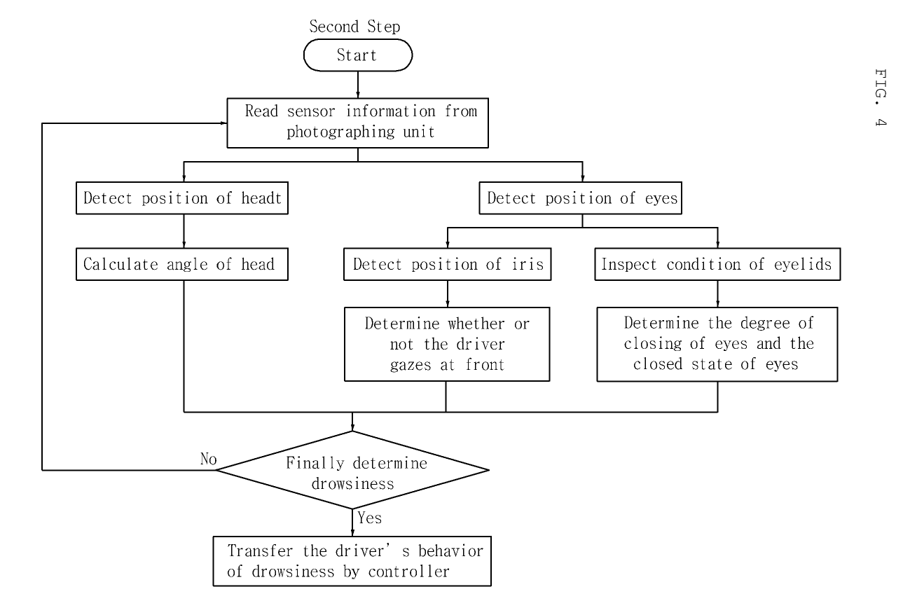

Meanwhile, the second step to judge the execution action state of the drowsiness, as illustrated in FIG. 4, judges that there is an execution action of the drowsiness when the driver who passes through the first step of the drowsiness prelude step closes the eyes for more than a predetermined period of time, when the driver does not look at the front for more than a predetermined period of time or when the driver bends his or her head at the predetermined angle for more than a predetermined period of time. An important characteristic of the present invention is that the present invention does not judge as the drowsy driving when an action similar to the action of the second step is directly detected without the drowsiness prelude action of the first step. Because the driver may show the second-step action for various different reasons other than drowsy driving, for instance, the driver may look out through the rearview mirror or the window, look at the room mirror or nods the head while listening to music, the actions must be discriminated from the second-step actions by drowsy driving without the drowsiness prelude action of the first step.

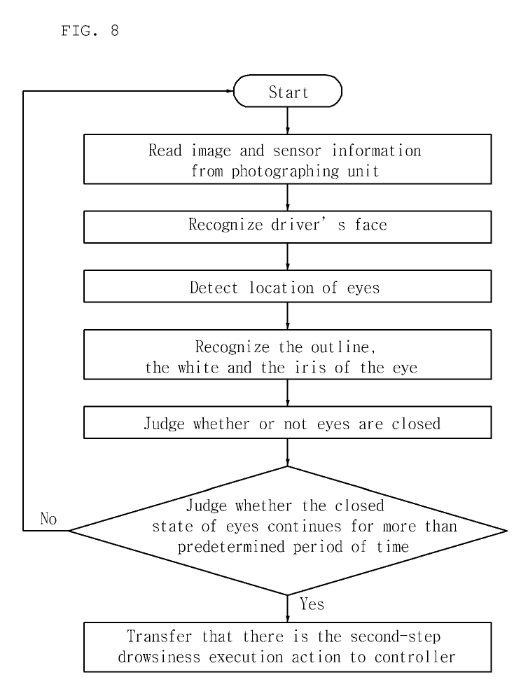

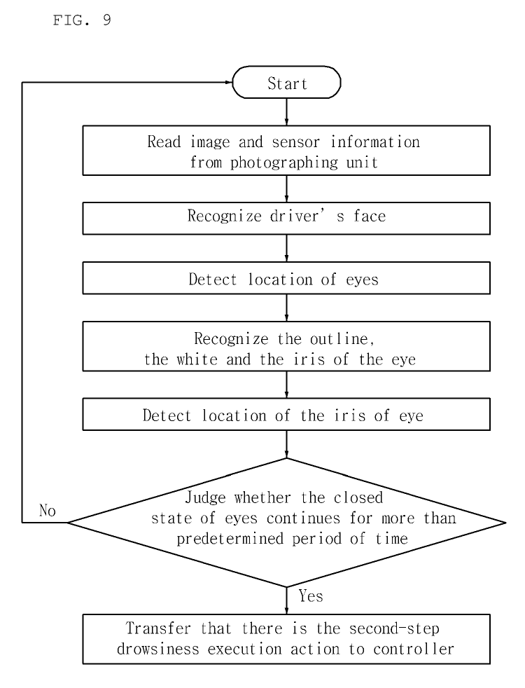

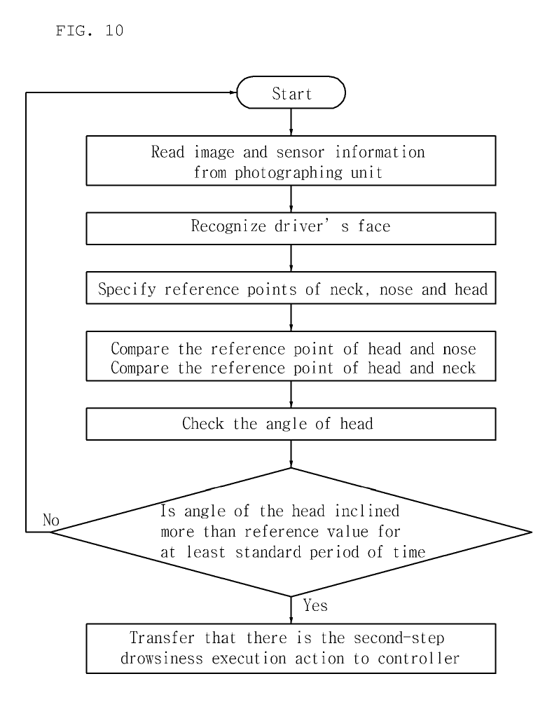

The closed state of the driver's eye, which is one of the criteria to judge the drowsiness execution action, as illustrated in FIG. 8, uses the image information received from the photographing unit to judge if the driver's pupil is closed more than a predetermined degree while sustaining the closed state for more than a predetermined time by analyzing the driver's pupil. The forward looking of the driver's eye, which is one of the criteria to judge the drowsiness execution action, as illustrated in FIG. 9, uses the image information received from the photographing unit to judge the drowsiness execution step when the time that the driver does not look at the front is continued for more than a predetermined period of time by analyzing the driver's pupil. The angle of the head, which is one of the criteria to judge the drowsiness execution action, as illustrated in FIG. 10, uses the image information received from the photographing unit to judge as the drowsiness execution step when the head is bent at more than a predetermined angle and continues the bent state for more than a reference time by calculating an angle between a reference point of the driver's head and a reference point of the driver's nose.

The warning unit, which warns the user, informs the driver of the drowsy driving state by generating a preliminary warning sound when the drowsiness prelude action of the first step is judged and generating the main warning sound when the drowsiness execution action of the second step is judged after passing the first step.

Furthermore, the controller to control the driving judging unit, the photographing unit, the drowsiness judging unit and the warning unit, as illustrated in FIG. 1 (Main figure) receives the forward driving state from the driving judging unit, transmits a photograph stop command to the photographing unit when the vehicle is stopped or driving backward, and transmits a first step drowsiness judging command to the drowsiness judging unit only when the vehicle is driving forward, sends a detection command to the photograph unit, transmits the second step drowsiness judging command to the drowsiness judging unit, and instructs the warning unit to send the preliminary warning sound after receiving information that the first step drowsiness prelude action exists from the drowsiness judging unit and instructs the warning unit to send the main warning sound to the driver when receiving information that the second step execution action of the drowsiness exists after passing the first step.

1. A two-step drowsy driving prevention apparatus through motion, face, pupil and mouth recognition, the apparatus comprising:
a driving judging unit to judge a forward driving state of a vehicle;
a photographing unit to photograph a driver's condition;
a drowsiness judging unit to judge whether or not the driver is driving while drowsiness;
a warning unit to generate a warning sound; and
a controller to control the driving judging unit, the photographing unit, the drowsiness judging unit and the warning unit,
wherein the driving judging unit comprises: a first-step judging process to judge a drowsiness prelude action through recognition of the driver's motion, face, pupil and mouth shape only when the vehicle is moving forward by receiving coordinate information of the current location of the vehicle from a GPS terminal and comparing the coordinate information with coordinate information of location for several seconds before the current location in order to judge whether the vehicle is driving forward, is driving backward or is stopped; and a second step judging process to judge a drowsiness execution action, so that the drowsy driving prevention apparatus finally determines that the driver is in drowsy driving and generates a warning sound only when it is judged that there is a drowsiness execution action in the second step determination process after it is determined that there is the drowsiness prelude action of the first step.

2. The two-step drowsy driving prevention apparatus according to claim 1, wherein the photographing unit to photograph the driver's condition comprises an infrared camera to receive image information of the driver's facial state and an infrared depth sensor to receive three-dimensional depth information

3. The two-step drowsy driving prevention apparatus according to claim 2, wherein the infrared camera receives the image information of the facial state and transmits the image information of the facial state to the drowsiness judging unit to recognize the driver's face outline, eye outline, white and iris of the eye in a bright area as well as in a dark area.

4. The two-step drowsy driving prevention apparatus according to claim 2, wherein the infrared depth sensor receives the three-dimensional depth information and transmits the three-dimensional depth information to the drowsiness judging unit to accurately judge locations and movements of the driver's upper body, head, face, eye and a mouth in a bright area as well as in a dark area.

5. The two-step drowsy driving prevention apparatus according to claim 1, wherein the drowsiness judging unit to judge the driver's drowsiness state is mounted to judge the drowsy driving state by receiving the image information from the infrared camera and the three-dimensional depth information from the infrared depth sensor only when the driving judging unit judges a forward driving state, and first recognizes whether or not the driver carries out any prelude action of drowsiness through the first-step judging process and judges whether or not the driver carries out drowsiness execution action through the second-step judging process, and then, finally determines drowsy driving only when going through the second step after passing the first step.

6. The two-step drowsy driving prevention apparatus according to claim 5, wherein the first step to judge the prelude action of the drowsiness judges the prelude action of the drowsiness by calculating a cycle of driver's yawn or calculating a speed and a cycle of nodding the head after first detecting the driver's face outline from image and sensor information transmitted from the photographing unit and detecting locations of the mouth, the head, the nose and the neck, or by calculating a speed and a cycle of blinking eyes after first detecting locations of the eyes and recognizing the outlines of the pupils and the whites and the irises of the pupils.

7. The two-step drowsy driving prevention apparatus according to claim 6, wherein the cycle of yawning, which is one of the criteria to judge the prelude action of the drowsiness uses the image and the sensor information received from the photographing unit to identify the location of the driver's mouth and to grasp whether or not the driver yawns based on the shape of the mouth or the degree of opening of the lower jaw, thereby judging that there is a drowsiness prelude action when the number of yawning cycles exceeds the standard of the yawning cycles within a predetermined period of time.

8. The two-step drowsy driving prevention apparatus according to claim 6, wherein the speed and the cycle of nodding the head, which is one of the criteria of judging the prelude action of the drowsiness uses the image and the sensor information received from the photographing unit to regard as one nod when the driver's head bends more than a predetermined angle and returns to its initial state, so that the drowsy driving prevention apparatus calculates as a “nod as the prelude of drowsiness” only when one nod of the head spends more time than the standard time and judges that the prelude action of the drowsiness exists when the nod as the prelude of the drowsiness occurs more than a reference number of nods within a predetermined time.

9. The two-step drowsy driving prevention apparatus according to claim 6, wherein the period of the yawn, which is one of a criteria of judging the prelude action of the drowsiness, uses the image and the sensor information received from the photographing unit to regard that the driver's pupils are covered more than a predetermined portion and then uncovered as one blink, so that the drowsy driving prevention apparatus calculates as a “blink as the prelude of drowsiness” only when one blink of the eyes spends more time than the standard time and judges that the prelude action of the drowsiness exists when the blink as the prelude of the drowsiness occurs more than a reference number of blinks within a predetermined time.

10. The two-step drowsy driving prevention apparatus according to claim 5, wherein the second step to judge the execution action state of the drowsiness judges that there is an execution action of the drowsiness when the driver who satisfies one of the criteria of the drowsiness prelude action of the first step closes the eyes for more than a predetermined period of time when the driver does not look at the front for more than a predetermined period of time or when the driver bends his or her head at the predetermined angle for more than a predetermined period of time.

11. The two-step drowsy driving prevention apparatus according to claim 10, wherein the closed state of the driver's eye, which is one of the criteria to judge the drowsiness execution action uses the image information received from the photographing unit to judge if the driver's pupil is closed more than a predetermined degree while sustaining the closed state for more than a predetermined time by analyzing the driver's pupil.

12. The two-step drowsy driving prevention apparatus according to claim 10, wherein the forward looking of the driver's eye, which is one of the criteria to judge the drowsiness execution action uses the image information received from the photographing unit to judge the drowsiness execution step when the time that the driver does not look at the front is continued for more than a predetermined period of time by analyzing the driver's pupil.

13. The two-step drowsy driving prevention apparatus according to claim 10, wherein the angle of the head, which is one of the criteria to judge the drowsiness execution action uses the image information received from the photographing unit to judge as the drowsiness execution step when the head is bent at more than a predetermined angle and continues the bent state for more than a reference time by calculating an angle between a reference point of the driver's head and a reference point of the driver's nose.

14. The two-step drowsy driving prevention apparatus according to claim 1, wherein the warning unit, which warns the user, informs the driver of the drowsy driving state by generating a preliminary warning sound when the drowsiness prelude action of the first step is judged and generating the main warning sound when the drowsiness execution action of the second step is judged after passing the first step.

15. The two-step drowsy driving prevention apparatus according to claim 1, wherein the controller to control the driving judging unit, the photographing unit, the drowsiness judging unit and the warning unit receives the forward driving state from the driving judging unit, transmits a photograph stop command to the photographing unit when the vehicle is stopped or driving backward, and transmits a first step drowsiness judging command to the drowsiness judging unit only when the vehicle is driving forward, sends a detection command to the photograph unit, transmits the second step drowsiness judging command to the drowsiness judging unit, and instructs the warning unit to send the preliminary warning sound after receiving information that the first step drowsiness prelude action exists from the drowsiness judging unit and instructs the warning unit to send the main warning sound to the driver when receiving information that the second step execution action of the drowsiness exists after passing the first step.
